(19) United States
(12) Patent Application Publication
(10) Pub. No.: US 2010/0203106 A1
(43) Pub. Date: Aug. 12, 2010

(54) METHOD FOR ENCAPSULATING AMINO ACIDS, VITAMINS AND MEDICATIONS AND METHOD FOR INCREASING RUMEN BYPASS OF AMINO ACIDS, VITAMINS AND MEDICATIONS

(75) Inventors: Charles A. MACGREGOR, Camano Island, WA (US); Mark R. KNOBBE, West Point, NE (US); Ambrose J. HUGO, West Point, NE (US)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: GRAIN STATES SOYA, INC., West Point, NE (US)

(21) Appl. No.: 12/367,170

(22) Filed: Feb. 6, 2009

(51) Int. Cl. A23K 1/20

(52) U.S. Cl. 424/438

(57) ABSTRACT

A method for encapsulating amino acids, vitamins and/or medications where the rumen bypass of the amino acids, vitamins and/or medications is increased. Ruminant supplements produced by the method for encapsulating, methods for producing milk and methods for increasing the production of milk protein.

### CROSS REFERENCE TO RELATED APPLICATIONS

Not Applicable

### STATEMENT REGARDING FEDERALLY SPONSORED RESEARCH OR DEVELOPMENT

Not Applicable

### NAMES OF PARTIES OF A JOINT RESEARCH AGREEMENT

Not Applicable

### INCORPORATION BY REFERENCE OF MATERIAL SUBMITTED ON A COMPACT DISC

Not Applicable

### BACKGROUND OF THE INVENTION

1. Field of the Invention

The present invention relates to amino acids and vitamins and medications and a process for encapsulating amino acids and vitamins and medications where the bypass rate of the amino acids and vitamins and medications through the rumen of a ruminant animal is increased.

A ruminant is an animal which possesses a complex stomach consisting of morphologically distinct compartments. In ruminant animals like cattle or sheep, there is a problem that occurs when a biologically active substance is, for instance, orally administered: a substantial part of the substance (e.g., proteins, amino acids, etc.) are decomposed to ammonia or carbon dioxide gas or other gases by microorganisms in the rumen, making it difficult or impossible for the animal to effectively utilize all of the administered proteins and amino acids contained in feed, etc.

Ruminants have biological requirements for essential amino acids. It is common practice in ruminant production to supply amino acids in the daily diet in the form of preformed protein in naturally occurring vegetable feedstuffs. A certain amount of the protein in a feedstuff, including the nonessential amino acids and the essential amino acids which comprise the protein in the feedstuff, can be destroyed by microbial fermentation in the rumen. Those essential amino acids that are destroyed are rendered unavailable for animal production. Animal production is limited by the supply of individual essential amino acids that escape, or bypass, the rumen intact and reach the lower gastrointestinal tract where they can be absorbed and become available for animal production.

When inadequate amounts of essential amino acids escape the rumen, the ruminant's production of milk and meat, as well as reproduction, are all negatively affected.

2. Description of Related Art

There are numerous methodologies designed to increase the amount of a nutrient that passes through the rumen without being degraded by the rumen microflora, thereby delivering a larger portion of that nutrient to the lower gastrointestinal tract.

U.S. Pat. No. 3,959,493 to Baalsrud et al. describes utilizing aliphatic fatty acids having at least 14 carbon atoms each. The fatty acids are applied as a coating to an individual nutrient. The fatty acids are said to be resistant to rumen degradation. The active agents then are delivered to the abomasum and/or intestine where the fatty acids are reduced in that post-ruminal environment.

U.S. Pat. No. 5,714,185 to Mahadevan describes treating protein substances with zein/formaldehyde to render the ingredients protected from rumen degradation. However, with regard to its impact on the nutritional quality of animal food products such as milk, the public has a negative perception of the use of formaldehyde in animal diets.

U.S. Pat. No. 5,093,128 to Draguesku et al, describes a beadlet nutrient coating which includes fats and calcium based products.

U.S. Patent Application 20020127259 to Orthoefer indicates that coated ruminant nutrients are disadvantageous due to cracking or abrading either in handling or in being masticated by the animal.

The University of Nebraska (Shain, et al, Effect of a Soybean Hull:Soy Lecithin:Soapstock Mixture on Ruminal Digestion and Performance of Growing Beef Calves and Lactating Dairy Cattle, Journal of Animal Science, 71:1266-1275, 1993) discloses the use of lecithin as an energy source in rations for dairy cattle. The lecithin was mixed with soy soap stock and with soybean hulls. This was done to make the lecithin practical to handle in a mixing system. Shain, et al does not disclose increasing rumen-bypass of protein (soap stock and soy hulls are low in protein). They demonstrated the “rumen-protected fat” characteristic of lecithin when used as an ingredient in the ration. Shain, et al does not disclose to coat an ingredient for the purpose of rendering the amino acids in that ingredient less subject to destruction in the rumen, before that ingredient was mixed into a ration. Nor does Shain, et al disclose to encapsulate amino acids or vitamins or medications with soy gums for the purpose of increasing rumen bypass of the amino acids or vitamins or medications.

The “rumen-protected fat” characteristic of lecithin has been noted in research at the University of Wisconsin (Gummer, Effect of Feed on the Composition of Milk Fat, Journal of Dairy Science, 74:3244-3257, 1991) and at Clemson University (Jenkins and Fotouchi, Effects of Lecithin and Corn Oil on Site of Digestion, Ruminal Fermentation and Microbial Protein Synthesis in Sheep, Journal of Animal Science 68:460-466, 1990). The lecithin was used as an ingredient in the ration. It was not used to coat an ingredient, rendering that ingredient less subject to destruction in the rumen, before that ingredient was mixed into a ration.

U.S. Pat. No. 5,227,166 to Ueda et al discloses a feed additive for ruminants comprising a core containing a biologically active substance and coating composition placed on the surface of the core. The coating composition comprises lecithin, at least one inorganic substance which is stable in neutrality and soluble under acidic conditions, and at least one substance selected from the group consisting of straight-chain or branched-chain saturated or unsaturated monocarboxylic acids having 14 to 22 carbon atoms, salts thereof, hardened vegetable oils, hardened animal oils, and waxes. Ueda et al does not disclose to encapsulate amino acids or vitamins or medications with soy gums for the purpose of increasing rumen bypass of the amino acids or vitamins or medications.

U.S. Pat. No. 5,871,773 to Rode et al discloses a method for supplementing the amino acid levels in ruminants where rumen protected amino acids, particularly lysine andor methionine, are used to supplement ruminant feed. Rode et al does not disclose to encapsulate amino acids or vitamins or medications with soy gums for the purpose of increasing rumen bypass of the amino acids or vitamins or medications.

U.S. Pat. No. 7,318,942 to Baricco et al discloses a feed supplement for increasing the plasma amino acid level of ruminant livestock and method of administration but does not disclose to encapsulate amino acids or vitamins or medications with soy gums for the purpose of increasing rumen bypass of the amino acids or vitamins or medications.

U.S. Pat. No. 7,297,356 to Macgregor et al (Grain States Soya, Inc., West Point, Nebraska) discloses the application of fresh gums from a seed or grain oil, which when applied to a feedstuff, results in an increase in the amount of that feedstuffs protein that passes through the rumen without being degraded by the rumen microflora. The effect is to increase the proportion of the feedstuff s protein, along with the nonessential and essential amino acids comprising that protein that bypasses the rumen without being degraded. The coated feedstuff product may contain additional feed additives.

### BRIEF SUMMARY OF THE INVENTION

It is an object of this invention to provide a method for encapsulating amino acids, vitamins and/or medications where the rumen bypass levels of the amino acids and vitamins and medications are increased.

One embodiment of the present invention is a process for encapsulating amino acids, vitamins and/or medications comprising: coating one or more amino acid, vitamin and/or medication with soy gums.

In addition to a process for encapsulating amino acids and/or vitamins and/or medications, the present invention also includes: a method for increasing the rumen bypass nature of amino acids, vitamins and/or medications, wherein said amino acids, vitamins and/or medications are encapsulated with soy gums, and wherein the rumen bypass nature of the encapsulated amino acids, vitamins and/or medications is increased relative to said amino acids and/or vitamins and/or medications being administered without being encapsulated.

The rumen-bypass nature of the encapsulated amino acids and vitamins and medications of the present invention is important for at least three reasons: 1) Increase Rumen-Bypass and Bioavailability of Essential Amino Acids, 2) Increase Rumen-Bypass and Bioavailability of Vitamins and 3) Increase Rumen-Bypass and Bioavailability of Medications.

### 1) Increase Rumen Bypass and Bioavailability of Essential Amino Acids

Ruminants require dietary essential amino acids. An inadequate level of any essential amino acid can limit animal production.

By coating essential amino acids with fresh soy gums, the rumen bypass nature of those essential amino acids can be increased. This reduces the amount of destruction experienced by those essential amino acids during transit through the rumen and increases their bioavailability to the animal. This results in more essential amino acids reaching the small intestine where they can be absorbed. As a result, the cow is able to produce more milk protein. That is an economic benefit to dairy producers.

The encapsulated amino acids of the invention, when fed to ruminants, tend to supply more rumen-bypass essential amino acids for production of milk and milk protein. Production of milk and milk protein by dairy cows benefits dairy producers economically.

### 2) Increase Rumen Bypass and Bioavailability of Vitamins

Ruminants require dietary vitamins. An inadequate level of any vitamin can limit animal production.

By coating a vitamin with soy gums, the rumen bypass nature of the vitamin can be increased. This reduces the amount of destruction experienced by the vitamin during transit through the rumen and increases its bioavailability to the animal. This results in more vitamin reaching the small intestine where it can be absorbed. As a result, the cow is able to produce more milk protein. That is an economic benefit to dairy producers.

The encapsulated vitamins of the invention, when fed to ruminants, tend to supply more rumen-bypass vitamin for production of milk and milk protein. Production of milk and milk protein by dairy cows benefits dairy producers economically.

### 3) Increase Rumen Bypass and Bioavailability of Medications

At times, ruminants require medications per os. Destruction of the medication in the rumen can limit the amount of medication reaching the target tissue and render the medication less effective.

By coating a medication with soy gums, the rumen bypass nature of the medication can be increased. This reduces the amount of destruction experienced by the medication during transit through the rumen and increases its bioavailability to the animal. This results in more medication reaching the small intestine where it can be absorbed. As a result, the medication is better able to reach the intended target tissue and improve the health status of the animal. That is an economic benefit to dairy producers.

The encapsulated medications of the invention, when fed to ruminants, tend to supply more rumen-bypass medication and less rumen destruction of the medication. That represents an economic saving and benefits dairy producers economically.

The ruminants include sheep and cattle. Preferably the ruminant is a dairy cow.

### BRIEF DESCRIPTION OF THE SEVERAL VIEWS OF THE DRAWINGS

Not Applicable

### DETAILED DESCRIPTION OF THE INVENTION

The encapsulating material are gums made from seed and/or grain of any type of seed or grain, for example, oilseeds, grains, beans, sunflower seeds, peas, canola seeds, soybeans, peanuts, cottonseeds, safflower seeds, sesame seeds, linseed seeds, corn, wheat, barley, sorghum, alfalfa, and pieces thereof or mixtures thereof.

U.S. Pat. No. 7,297,356 discloses methods of making gums and cake. U.S. Pat. No. 7,297,356 is incorporated by reference herein in its entirety.

Soybean gums are a preferable type of encapsulating material.

The gums are made by extracting crude oil from the seed and/or grain pieces to produce a cake and the crude oil; and separating the crude oil into wet gums and a degummed oil. Gums may be extracted from crude oil by hydration and centrifugation. Using mechanical extraction allows for an all-natural process, where only heat and pressure are utilized and no chemicals are utilized. The cake produced is a feedstuff that is typically used as a feedstuff after being reduced in size by a hammer mill.

The gums and encapsulated amino acids, vitamins and/or medications may be used without a carrier. For example, the gums and encapsulated amino acids, vitamins and/or medications do not comprise the cake.

The gums and encapsulated amino acids, vitamins and/or medications may be used on a carrier of a different composition or material than the gums. The carrier may be the cake or other types of animal compatible carriers, for example, solvent extracted soybean meal, solvent extracted rapeseed meal (also called canola meal), mechanical extracted rapeseed meal (also called canola meal), corn, wheat, soybean hulls, wheat middlings, wheat millrun, wheat bran, rice bran. In one embodiment of the invention the cake does not comprise the additives that are encapsulated in the gums. In one embodiment of the invention the cake comprises additives such as amino acids, vitamins and/or medications.

Preferably the gums used as the encapsulating material are fresh hot wet gums. The amino acids, vitamins and/or medications may be mixed with the gums while the gums are still wet, warm and fresh. That is, the gums are not allowed to dry and are not cooled to ambient temperature prior to adding the amino acids or vitamins or medications.

The soy gums may be at a temperature of above 100° F. when the amino acids, vitamins and/or medications are added to the gums. The soy gums may be at a temperature of from 100° F. to 210° F. when the amino acids, vitamins and/or medications are added to the gums. The wet gums may be at a temperature of from 106° to 112° F. when added to the mixer. In one non-limiting example, the wet gums were at a temperature of from 109° to 110° F. when added to the mixer.

Any mixing process may be used to mix the gums and the amino acids or vitamins or medications. An example of a mixer is a cut-and-fold mixing auger. Mixing water may be added. The water may be added to the mixer, for example, at the mid-point of the mixing auger, and may be at a temperature of at least 45° F., preferably 45° to 60° F.

The amino acids, vitamins and/or medications may also be encapsulated in the gums by adding the amino acids, vitamins and/or medications to the soy gums and pumping the mixture through a sequence of pump and mixing lines. For example, a static mixer may be used as the mixing line.

In one non-limiting example of amino acid encapsulated with gums, fresh, hot gums and the amino acid were placed together in a holding container. From the holding container the gums and amino acid were pumped together by a positive displacement pump through a twenty-one inch long pipe, then through a twenty-four inch long static mixer and then through another twenty-one inch long pipe.

Following mixing, the gums/amino acid mix may be applied onto cake, or whatever carrier one would choose, or dried to form the encapsulated material without a carrier.

An element of the present invention is encapsulating the amino acids, vitamins and/or medications while the gums are hot. If hot fresh gums are not used as described above, the hot gums may be formed from previously made gums which are heated for use. The heating may be at the same temperatures as used with hot fresh gums or may be at a higher temperature. Water may be added when heating the gums. In one non-limiting example discussed in further detail below, amino acids were encapsulated with soy gums, soybean meal, with heat at 240° F.

When used with a carrier, the gums and encapsulated amino acid, vitamin and/or medication coated on the carrier may also be fresh and are not allowed to dry and are not allowed to cool to ambient temperature prior to coating on the carrier. Any mixing process may be used to coat the wet gums and encapsulated material on the carrier. The coating may be performed in a mixer with the addition of water. The water may help to disperse the gums so that more of the cake is “treated” with gums. An example of a mixer is a cut-and-fold mixing auger.

When a cake is used as the carrier, it may enter the mixer from the crude oil extraction process while also still warm and fresh. The term “coating” also includes the wet gums soaking into or absorbing into the cake.

Preferably the encapsulated material is at least one amino acid. The amino acids may be amino acids or amino acid analogues or amino acid derivatives or a combination of these. Preferably the amino acids are at least one amino acid selected from the group consisiting of lysine, methionine, arginine, histidine, isoleucine, leucine, threonine, tryptophan and valine. More preferably the amino acid is at least one amino acid selected from the group consisting of lysine and methionine.

Examples of lysine are l-lysine monohydrochloride, l-lysine free base and lysine sulfate. Examples of methionine are dl-methionine, methionine hydroxyl analogue (MHA) (also known as 2-hydroxy-4-methylthio butanoic acid (HMB)).

The amino acids, vitamins and/or medications may be added to the gums in liquid form or solid (such as powder) form. The amino acid, vitamin and/or medication may be added directly into the gums.

The encapsulated material may be lysine and/or methionine coated with soy gums as the encapsulating material.

The encapsulated material may be selected from the vitamins choline and niacin coated with soy gums as the encapsulating material. Other non-limiting examples of vitamins are cyanocobalamin, folic acid, inositol, pantothenic acid, pyridoxine, riboflavin and thiamine.

The encapsulated material may be selected from the antibiotic medicine coated with soy gums as the encapsulating material.

The encapsulated material may be a ruminant supplement. The encapsulated material may be a ruminant feed supplement. The encapsulated material may be administered alone with other additives commonly given to a ruminant, such as other supplements or with a feed.

### EXAMPLES

### Feed Trail 1 and Feed Trail 2

Two trials were conducted under laboratory conditions at West Virginia University.

Encapsulation of Methionine

Encapsulating the dl-methionine with soy gums without heat had no effect on rumen degradation and rumen bypass of the encapsulated amino acid.

Encapsulating di-methionine with soy gums with heat decreased rumen degradation and increased rumen bypass of the methionine.

Encapsulation of L-Lysine Hvdrochloride

Encapsulating the l-lysine monohydrochloride with soy gums without heat had no effect on rumen degradation and rumen bypass of the encapsulated amino acid.

Encapsulating l-lysine monohydrochloride with gums with heat decreased rumen degradation and increase rumen bypass of the lysine.

Procedures:

Two trials were conducted at the Rumen Fermentation Profiling Laboratory, University of West Virginia. In both trials, samples were placed in dacron bags which were suspended in the rumen of a cow for certain periods of time. All samples were run in triplicate.

### Trial #1 Included Two Treatments:

1. Choline, methionine, lysine, soy hulls, no gums, no heat,

2. Choline, methionine and lysine encapsulated with soy gums, soy hulls, no heat, added.

### Trial #2 Included Two Treatments:

1. Lysine, methionine, soybean meal (solvent extracted soybean meal), no gums, no heat.

2. Lysine and methionine encapsulated with soy gums, soybean meal, with heat (240° F. for 9 minutes) (Methionine and lysine were mixed into the gums before the gums were applied to the soybean meal. After the mixture was applied to the meal, that material was then heated.

### Results:

The results are shown in Table 1.

Trial #1 results: Compared to no encapsulation with gums, encapsulation with gums and without heat had no effect on rumen degradation and rumen bypass.

Trial #2 results: Compared to encapsulation with gums and without heat, encapsulation with gums and with heat caused a decrease in the rumen degradation and an increase in rumen bypass of lysine and methionine.

TABLE 1
Results of two in situ trials --- rumen degradability rates, laboratory
conditions.

| TRIAL #1 | | TRIAL #2 | | |
|---|---|---|---|---|
| Treatment: | | | | |
| Without | With | | | |
| Encapsulation | Encapsulation | Without | With | Less Rumen |
| No Heat | No Heat | Encapsulation | Encapsulation | Degradation (and |
| Choline | Choline | No Heat | 240° F., 9 min | More Rumen |
| Methionine | Methionine | Methionine | Methionine | Bypass) Due to |
| Lysine | Lysine | Lysine | Lysine | Heat |
| soy hulls | soy hulls | SBM | SBM | % difference, |

| | |
|---|---|
| In Situ Rumen Degradation Rate, % | w/ heat vs w/o heat |

Dry Matter

| | | | | | |
|---|---|---|---|---|---|
| 1 hr | 20.71 | 23.45 | 44.41 | 42.51 | 4.47% |
| 3 hrs | 22.02 | 27.16 | | | |
| 6 hrs | 28.85 | 32.73 | | | |
| 12 hrs | 33.28 | 38.86 | | | |

Crude Protein

| | | | | | |
|---|---|---|---|---|---|
| 1 hr | 41.88 | 41.53 | 28.82 | 22.94 | 25.63% |
| 3 hrs | 43.31 | 47.28 | | | |
| 6 hrs | 53.03 | 55.23 | | | |
| 12 hrs | 56.01 | 61.22 | | | |

Choline

| | | |
|---|---|---|
| 1 hr | 75.96 | 80.00 |
| 3 hrs | 88.71 | 87.83 |
| 6 hrs | 85.08 | 91.90 |
| 12 hrs | 94.10 | 100.00 |

Methionine

| | | | | | |
|---|---|---|---|---|---|
| 1 hr | 73.57 | 74.49 | 44.61 | 32.65 | 36.63% |
| 3 hrs | 74.75 | 76.50 | | | |
| 6 hrs | 78.44 | 80.47 | | | |
| 12 hrs | 80.44 | 82.25 | | | |

Lysine

| | | | | | |
|---|---|---|---|---|---|
| 1 hr | 43.40 | 46.03 | 32.65 | 29.57 | 10.42% |
| 3 hrs | 45.04 | 50.95 | | | |
| 6 hrs | 53.21 | 57.10 | | | |
| 12 hrs | 56.35 | 62.77 | | | |

Feed Trail 3

Trial 3 was conducted under production conditions. Products were made at the Grain States Soya, Inc. manufacturing plant in West Point, Nebraska. Analyses were conducted at West Virginia University and the University of Missouri.

Encapsulation of L-Lysine Monohydrochloride

Encapsulating l-lysine monohydrochloride with soy gums increased the rumen bypass of the lysine from 43.16% with no encapsulation to 98.67% with encapsulation.

TABLE 2
Result of in situ trial - rumen degradability rates, production conditions.
Raw Data for 8 hour in vitro

| | | | | | | | Spl | | | | |
|---|---|---|---|---|---|---|---|---|---|---|---|
| | Original Sample | | Spl | Spl | Base | Added | Total | Residue Undigested Sample | | | |
| Sample | Spl wt | DM | DM | Lys % | Lys g | Lys g | Lys g | Residue | % DM | DM | % Lysine |
| Lys w/ gums | 9.0007 | 92.14% | 8.2932 | 2.98% | 0.221 | 0.026 | 0.247 | 4.9735 | 99.01 | 4.92 | 3.75 |
| meal #3 | 9.0003 | 92.14% | 8.2929 | 2.98% | 0.221 | 0.026 | 0.247 | 4.6873 | 99.56 | 4.67 | 3.71 |
| 100708 | 9.0001 | 92.14% | 8.2927 | 2.98% | 0.221 | 0.026 | 0.247 | 4.2827 | 99.71 | 4.27 | 3.88 |
| | | | 8.2929 | 2.98% | 0.221 | 0.02613 | 0.247 | | | 4.62 | 3.78 |
| No Lys | 9.0006 | 88.58% | 7.9727 | 2.67% | 0.213 | 0.000 | 0.213 | 4.3675 | 99.81 | 4.36 | 3.44 |
| meal #2 | 9.0004 | 88.58% | 7.9726 | 2.67% | 0.213 | 0.000 | 0.213 | 3.7177 | 99.60 | 3.70 | 3.57 |
| 100608 | 9.0002 | 88.58% | 7.9724 | 2.67% | 0.213 | 0.000 | 0.213 | 4.5314 | 99.90 | 4.53 | 3.27 |
| | | | | | | | | | | | 3.43 |
| Lys w/o gums | 9.0007 | 88.58% | 7.9728 | 2.67% | 0.213 | | 0.250 | 3.9654 | 99.50 | 3.95 | 3.96 |
| meal #2 | 0.0470 | | 0.0470 | 78.80% | | 0.037 | | | | | |
| 100608 | 9.0001 | 88.58% | 7.9723 | 2.67% | 0.213 | | 0.250 | 4.1383 | 99.60 | 4.12 | 3.91 |
| | 0.0469 | | 0.0469 | 78.80% | | 0.037 | | | | | |
| | 9.0000 | 88.58% | 7.9722 | 2.67% | 0.213 | | 0.250 | 4.3691 | 99.60 | 4.35 | 3.69 |
| | 0.0467 | | 0.0467 | 78.80% | | 0.037 | | | | | 3.85 |

| | | | Res | | | Total |
|---|---|---|---|---|---|---|
| | Base | Added | Total | Bypass of | Bypass of | Bypass of |
| Sample | Lys g | Lys g | Lys g | Add Lys | Base Lys | Total Lys |
| Lys w/ gums | 0.149 | 0.036 | 0.184660926 | | 67.36% | 74.72% |
| meal #3 | 0.149 | 0.024 | 0.173135387 | | 67.36% | 70.06% |
| 100708 | 0.149 | 0.017 | 0.165686234 | | 67.36% | 67.05% |
| | 0.149 | 0.02578 | 0.17465209 | 98.67% | 67.36% | 70.67% |
| No Lys | 0.150 | | 0.149956901 | NA | 70.44% | 70.44% |
| meal #2 | 0.132 | | 0.132191539 | NA | 62.10% | 62.10% |
| 100608 | 0.148 | | 0.148029383 | NA | 69.54% | 69.54% |
| | | | | | 67.36% | 67.36% |
| Lys w/o gums | 0.143 | | 0.156243005 | | | 62.52% |
| meal #2 | | 0.013 | | 34.68% | | |
| 100608 | 0.143 | | 0.161159859 | | | 64.51% |
| | | 0.018 | | 48.09% | | |
| | 0.143 | | 0.160574487 | | | 64.32% |
| | | 0.017 | | 46.71% | | |
| | | | | 43.16% | | 63.78% |

The bypass rate for added lysine in the three individual replications ranged from 65% to 100%.

The rumen bypass rate of encapsulated lysine was 2.29 times greater (98.67/43.16) or 128% greater ((98.67−43.16)/43.16×100) than the rumen bypass rate of unencapsulated lysine. These results were very surprising and unexpected from the knowledge in the art.

Although specific embodiments of the present invention have been described above and illustrated in the accompanying tables in order to be more clearly understood, the above description is made by way of example and not as a limitation to the scope of the present invention. It is contemplated that various modifications apparent to one of ordinary skill in the art could be made without departing from the scope of the invention which is to be determined by the following claims.

We claim:

1. A ruminant supplement comprising
a component selected from the group consisting of an amino acid, an amino acid analogue, an amino acid derivative, a vitamin, and a medicine
coated with seed and/or grain gums.

2. The ruminant supplement of claim 1, wherein said gums are soy gums.

3. The ruminant supplement of claim 2, wherein said component is selected from the group consisting of an amino acid, an amino acid analogue, and an amino acid derivative.

4. The ruminant supplement of claim 2, wherein said component is selected from the group consisting of l-lysine monohydrochloride, l-lysine free base, lysine sulfate, dl-methionine, 2-hydroxy-4-methylthio butanoic acid (HMB)).

5. The ruminant supplement of claim 2, wherein said component is selected from the group consisting choline, niacin, cyanocobalamin, folic acid, inositol, pantothenic acid, pyridoxine, riboflavin and thiamine and an antibiotic.

6. The ruminant supplement of claim 2, further comprising a cake feedstuff, wherein the coated component is coated on said cake feedstuff.

7. A method for increasing the rumen bypass nature of an amino acid in a ruminant comprising:
administering the ruminant supplement of claim 3 to a ruminant.

8. The method for increasing the rumen bypass nature of an amino acid in a ruminant of claim 7, wherein said component is selected from the group consisting of l-lysine monohydrochloride, l-lysine free base, lysine sulfate, dl-methionine, 2-hydroxy-4-methylthio butanoic acid (HMB)).

9. The method for increasing the rumen bypass nature of an amino acid in a ruminant of claim 7, wherein said ruminant is a dairy cow.

10. A method for increasing the rumen bypass nature of a vitamin or a medicine in a ruminant comprising administering the ruminant supplement of claim 5 to a ruminant.

11. The method for increasing the rumen bypass nature of a vitamin or a medicine in a ruminant of claim 10, wherein said vitamin or medicine is selected from the group consisting of choline, niacin, cyanocobalamin, folic acid, inositol, pantothenic acid, pyridoxine, riboflavin and thiamine and an antibiotic.

12. A method for making a ruminant supplement comprising:
coating a component selected from the group consisting of an amino acid, an amino acid analogue, an amino acid derivative, a vitamin, and a medicine
with seed and/or grain gums.

13. The method for encapsulating an amino acid of claim 12, wherein said gums are hot soy gums at a temperature of above 100° F.

14. The method for encapsulating an amino acid of claim 12, wherein said gums are hot fresh soy gums.

15. The method for encapsulating an amino acid of claim 13, wherein said component is selected from the group consisting of l-lysine monohydrochloride, l-lysine free base, lysine sulfate, dl-methionine, 2-hydroxy-4-methylthio butanoic acid (HMB)).

16. The method for encapsulating a vitamin or a medicine of claim 13, wherein said component is selected from the group consisting of choline, niacin cyanocobalamin, folic acid, inositol, pantothenic acid, pyridoxine, riboflavin and thiamine, and an antibiotic.

17. A method for producing milk comprising
coating a component selected from the group consisting of an amino acid, an amino acid analogue, an amino acid derivative, a vitamin, and a medicine with seed and/or grain gums and
feeding the coated component to a dairy cow.

18. The method for producing milk of claim 17, wherein said component is selected from the group consisting of l-lysine monohydrochloride, l-lysine free base, lysine sulfate, dl-methionine, 2-hydroxy-4-methylthio butanoic acid (HMB)).

19. Milk produced by the process of claim 18.

20. A method for producing milk protein in a dairy cow comprising
coating a component selected from the group consisting of an amino acid, an amino acid analogue, an amino acid derivative, a vitamin, and a medicine with seed and/or grain gums and
feeding the coated component to a dairy cow.

21. The method for producing milk protein in a dairy cow of claim 20, wherein said component is selected from the group consisting of l-lysine monohydrochloride, l-lysine free base, lysine sulfate, dl-methionine, 2-hydroxy-4-methylthio butanoic acid (HMB)).
